(19) United States
(12) Patent Application Publication
(10) Pub. No.: US 2007/0237552 A1
(43) Pub. Date: Oct. 11, 2007

(54) Doctor Blade and Developer Assembly with Precision Diameter Radius for Improved Doctoring Consistency

(76) Inventors: Robert Watson McAlpine, Lexington, KY (US); Donald Wayne Stafford, Georgetown, KY (US); Gregory Scott Tigges, Frankfort, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/278,862

(22) Filed: Apr. 6, 2006

(51) Int. Cl. G03G 15/08

(52) U.S. Cl. 399/284

(57) ABSTRACT

A doctor blade (10) having a steel rod (11) attached to a stamped bracket (20) provides a radiused surface for contacting a developer roll (12). The doctor blade (10 ) includes a bracket member (20) having a mounting end (42), a doctoring end (44) and a bent portion (14) connecting the mounting end (42) to the doctoring end (44). The rod (11) is coupled to the bracket member (20) near the bent portion (14) and arranged to contact a developer roll (12) for precise toner metering.

### TECHNICAL FIELD

The invention relates to doctor blades for metering electrophotographic toner held on a developer roller by physically contacting a surface of the roller with the blade. More particularly, the invention is directed to a flexible doctor blade having a radiused end for contacting the developer roll surface instead of a conventional flat surface. Still more particularly, the invention is directed to a doctor blade design that uses a stamped metal bracket to which a piece of precision steel rod is attached to precisely meter toner onto the developer roll.

### BACKGROUND OF THE INVENTION

In electrophotographic printers that used a developer roll to carry toner to the photoconductor, it is necessary to provide a means of metering the toner to produce a thin, uniform layer of toner on the developer. FIG. 1 shows a typical prior art developer. Toner 1 is coated on the developer roll 2 by a toner adder roll 3. As the developer roll 2 rotates it carries the toner 1 to a doctor blade 4 which is pressed against the developer roll 2 by a doctor blade spring 5. The pressure that is generated in the nip between the doctor blade 4 and developer roll 2 causes the formation of a layer of toner 6 that is then carried to the photoconductor 7 where the latent image is developed. The amount and uniformity, of toner that passes under the doctor blade 4 is a function of, among other things, the pressure in the nip with higher pressures producing les mass per unit area. The torque needed to turn the developer roll 2 is a function of the force of the doctor blade spring 5 and the coefficient of friction between the doctor blade 4 and developer roll 2.

Prior art toner metering systems include the use of a flat steel doctor blade on a rubber or urethane developer roll. These components are controlled to tight straightness and runout tolerances in order to control the uniformity of toner flow. Another approach involves the use of a flat sandpaper blade with a foam backing as illustrated and described in U.S. Pat. No. 5,708,943 issued Jan. 13, 1998, U.S. Pat. No. 5,702,812 issued Dec. 30, 1997 and U.S. Pat. No. 5,623,718 issued Apr. 22, 1997, all assigned to the assignee of this invention. The compliance of the foam backing reduces tolerances and costs of the components, but the frictional torque is still the primary source of torque in the developer.

Both the flat steel blade and flat sandpaper flex blade have known problems. For example, toner can become packed in the forward region of the flat doctor blade. Another problem occurs when a wedge of toner is formed that becomes compacted to the point that its cohesive strength and adhesion to the blade can produce a blockage of toner. This prevents toner from entering the nip and results in vertical white streaks in print.

Still another approach involves the use of a blade with a radiused contact surface in the form of a bent edge near on the metal stamping used to form the doctor blade. However, the manufacturing operation to bend the stamping may not result in a consistent radius along the length of the part. As such, those skilled in the art continue to explore ways of maintaining doctoring consistency.

One solution to some of these difficulties was the use of a compliant doctor blade having a conductive metal bar with a lower surface to which a resilient layer is attached. The lower surface of the resilient layer has attached to it a stiff shim. The stiff shim has a bottom layer of conductive and abrasive material. At one end of the doctor blade a resilient conductive coating bridges the abrasive layer and the metal bar. If desired, the blade is at an angle with the surface of the developer roller—see U.S. Pat. No. 5,797,076, issued Aug. 18, 1998, assigned to the assignee of this invention.

A second solution to the problems discussed above was disclosed in U.S. Pat. Nos. 5,400,128 and 5,237,375, which were directed to wiper and spreader blades with conductive coatings. The wiper blade removed excess toner from the photosensitive drum and the spreader blade controls and adjusts the quantity of toner on the developing cylinder.

While such solutions have, to some extent, improved toner metering performance, developer roll and doctor blade tolerances can still impact the precision of with which toner particles are doctored unto the developer roll. As such, there remains a need for more precision of the toner metering process. At the same time, nowhere is there disclosed or suggested the novel doctor blade according to the present invention.

Accordingly, it is an object of the present invention to provide a doctor blade for use in an electrophotographic process which consists of a radiused end.

Another object of the present invention is to provide a doctor blade for use in an electrophotographic process which is less sensitive to developer roll and doctor blade tolerances.

### BRIEF DESCRIPTION OF THE DRAWINGS

The present invention is illustrated by way of example and not limitation in the figures of the accompanying drawings in which like references indicate similar elements, and in which:

FIG. 1 is a typical developer having a conventional doctor blade of the prior art;

FIG. 2A is a further view of the flat doctor blade in contact with the developer roll;

FIG. 2B is an enlarged view of a flat doctor blade in the circled region of FIG. 2A of the prior art showing how toner builds up in the forward region of the blade;

FIGS. 3A and 3B are perspective views of a doctor blade according to the present invention;

FIG. 4 is a cross-section of the doctor blade in a toner metering position according to the present invention; and

FIG. 5 is a cross-section of a developer assembly utilizing a doctor blade according to the present invention.

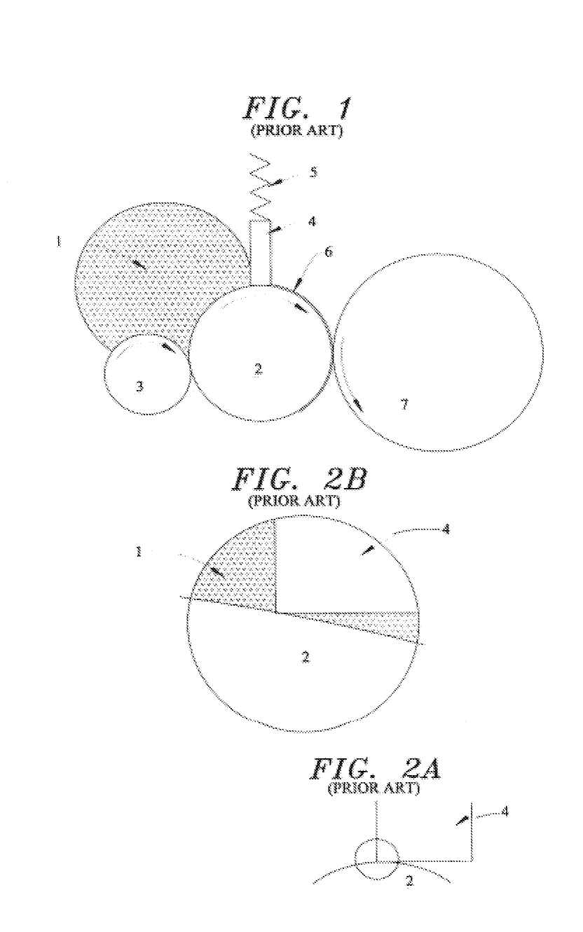

### DETAILED DESCRIPTION

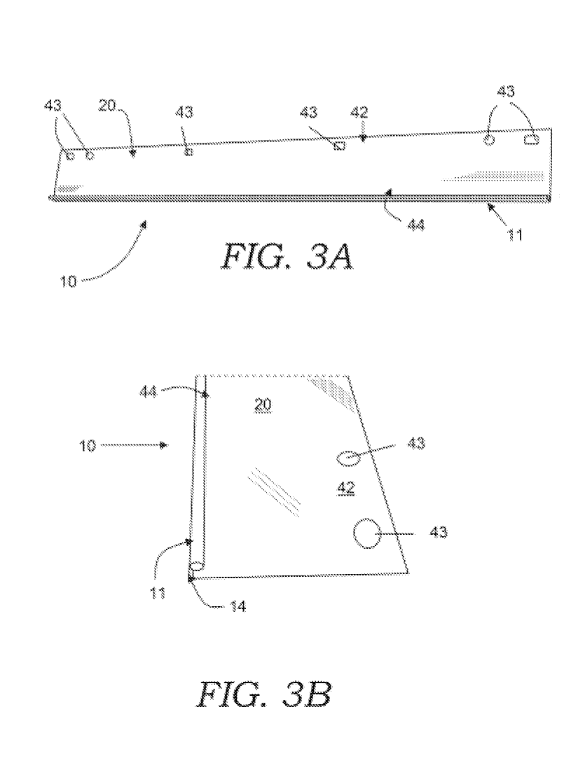

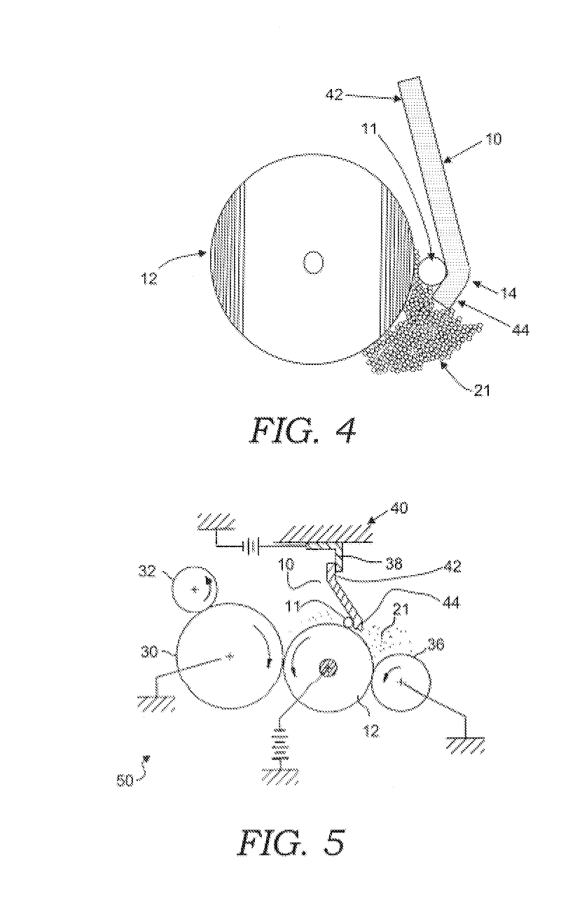

A doctor blade according to the present invention is used for electrophotography or copying and is depicted in FIGS. 3A, 3B and 4. As shown, a doctor blade 10 may have a rod member 11 that contacts the developer roll 12. For convenience the terms “rod member,” “rod,” and “steel rod” shall be used interchangeably throughout. Preferably, rod 11 is made of steel or other hardened metallic and conductive material to ensure a precise nip is formed between the doctor blade 10 and the developer roll 12. Since it is possible to manufacture a rod-shaped structure so that it provides a consistent radiused curvature along its length, the use of rod 11 for doctoring toner across the surface of the developer roller 12 improves toner metering performance.

As shown, the rod 11 is attached to a bracket 20 which consists of a mounting end 42 and the doctoring end 44 coupled to each other via a bent portion 14. Mounting holes 43 are provided about the mounting end 42 of the bracket 20 to facilitate attachment of the doctor blade 10 to a support structure of developer assembly, as shown, FIG. 5. Rod 11 is attached to doctor blade 10 near the bent portion 14 of the doctor blade 10 which is preferably flexible and made of a conductive material such as a stamped sheet of steel. The radius of the rod 11 can be determined based on the desired force to be applied to the developer roll 12 and the physical characteristics of the bracket 20.

The radius of the rod 11 is preferably substantially less than the radius of the developer roll 12 and within a range of desired radius. A smaller radius of the rod 11 achieves metering pressure with lower force, lower torque and less frictional heating. The smaller radius provides an exit path for toner in the pre-nip region between the doctor blade 10 and the developer roll 12, thereby reducing the charging of the developer roll 12. A larger radius for the rod 11 may provide for more opportunity for toner charging and may be less sensitive to defects in geometry of the doctor blade 10. Depending on the desired result, a radius for the doctor blade 10 is selected which provides a number of benefits during electrophotography.

Flexibility of the stamped bracket 20 limits the need for springs which load the doctor blade 10 against the developer roll 12. The rod 11 is a cylindrically shaped with a predetermined radius and is preferably constructed of steel or a similarly conductive material.

The surface of the rod 11 is critical to smooth metering of toner. The surface of the rod 11 preferably has an average roughness (Ra) of less than 0.5 micrometers and substantially free of any imperfections. The doctor blade 10 of the present invention can be used with seals in current printer cartridge designs. Its use has reduced torque produced by blade friction when compared to conventional steel blades.

Thus, the present invention provides a doctor blade 19 that uses a stamped metal bracket 20, to which a piece of precision steel rod 11 is attached to precisely meter toner 21 onto the developer roll 12. One edge of the stamped bracket 20 contains a bent portion 14 to provide positioning for the steel rod 11. This same feature, or others, may be used to aid in retention of the rod 11 during operation. The steel rod 11 can be welded or otherwise adhered to the stamped bracket 20 at about the bent portion 14. The stamped bracket 20 may be positioned in the developer assembly in such a way to provide force on the developer roll 12 with the steel rod 11 as the line of contact, as depicted in FIG. 4. Dimensions of the stamped bracket 20 can be modified to supply the necessary force needed for doctoring.

Use of precision steel rod 11 yields a more consistent radius for doctoring allowing for amore uniform layer of toner 21 to be doctored onto the developer roll 12. Using a steel rod 11 for the doctoring nip also allows different materials to be selected for the bracket 20 and rod 11. Each material can be optimized for purpose to provide the best doctoring surface and proper doctoring force. This would make possible the use of wear resistant materials for the rod 11 thus eliminating the need for coating or plating if a common material was chosen.

In addition, rod 11 provides an increased amount of radiused surface which increases the consistency of metering. The bent portion 14 in a bracket 20 may be limited to the amount of radiused surface available making position of the bracket 20 more critical. The use of a rod 11 can accommodate more variations in position while still allowing contact of a radiused surface to the developer roll 12.

In addition, quality inspection may also be improved with the use of a steel rod 11. A small bend radius in a stamped bracket 20 can be difficult to measure. In, contrast, rod 11 provides a simpler means for measurement prior to assembly.

Referring to FIG. 4, a developer assembly 50 utilizing the doctor blade 10 according to the invention is depicted and may include a photosensitive drum 30 rotating clockwise, and a charging roller 32 for uniformly charging a surface of the photosensitive drum 30 is installed so as to contact the surface of the photosensitive drum 30, and the developer roller 12 for forming a toner image on an electrostatic latent image of the photosensitive drum 30 is installed on one side of the photosensitive drum 30. The developing roller 12 has a direct current voltage which may be within the range of between about −200 V to −500 V applied thereto and is made of a conductive rubber material and has a specified electrical resistance.

A supplying roller 36 for supplying toner 21 agitated by an agitator (not shown) onto the developing roller 12 is installed on one side of the developing roller 12, and a doctor blade 10 for regulating the toner 21 layer formed on the developing roller 14 so as to be at a uniform thickness is installed above the developing roller 12. Rod 11 of doctor blade 10 contacts the surface of the developing roller 12 at a given pressure. Furthermore, the specific arrangement of the doctor blade 10 is dictated by the relative position of mount 38, the angle in which the doctor blade 20 is held by mounting bracket 38, the extension of the mounting end 42 of doctor blade 10 from the mounting bracket 38 to developer roller 12, the relative flexibility of the material forming the doctor blade 10 and other variables all of which are design factors based on the specific application in which developer 50 is utilized. Such design factors are well known to those of ordinary skill in the art.

In the preferred embodiment, doctor blade 10 is made of a metallic conductor such as steel which is stamped from a sheet of to a desired shape and size. A contact direction of the rod 11 of the doctor blade 10 and the developing roller 12 is opposite to a transfer direction of the toner 21 formed on the surface of the developing roller 12 to the photosensitive drum 30. As shown, the mounting bracket 38 may have two perpendicular arms for supporting the doctor blade 10 to one side of the doctor blade 10. In the drawings, the doctor blade 10 is installed to the left of the bracket 38, but it may be installed to the right thereof or on another configuration as is well understood by those of ordinary skill.

Hereinafter, the operation and effects of the developer assembly 50 constructed as previously described in accordance with the present invention is explained. Toner 21 agitated by the agitator (not shown) installed in the toner storing unit (not shown) is supplied the developing roller 12 as the supplying roller 36 rotates counterclockwise, and then supplied toner 21 is transferred to the developing roller 12 by the magnetic force of the developing roller 12. Hereafter, the doctor blade 10 regulates the toner 21 formed on the developing roller 12 so as to be at an uniform thickness and at the same time, controls the amount of toner 21 by means of the elasticity induced due to the elastic displacement thereof of the doctor blade 10 and the surface of the developer roller 12.

Since minor changes and modifications varied to fit particular operating requirements and environments will be understood by those skilled in the art, the invention is not limited to the specific examples chosen for purposes of illustration, and includes all changes and modifications which do not constitute a departure from the spirit and scope of this invention as claimed in the following claims and reasonable equivalents to the claimed elements.

What is claimed is:

1. A doctor blade for metering electrophotographic toner on a surface of a developer roller, said blade comprising:
a bracket member having a mounting end, a doctoring end and a bent portion connecting said mounting and said doctoring end;
a rod member coupled to said bracket member near said bent portion; and
wherein said rod member is electrically conductive and arranged to contact said developer roll during a toner metering process.

2. The doctor blade as claimed in claim 1, wherein said rod member is a steel rod.

3. The doctor blade as claimed in claim 1, wherein said rod member is a steel rod welded to said bracket member.

4. The doctor blade as claimed in claim 3, wherein said rod member is welded to said bracket member at said bent portion.

5. The doctor blade as claimed in claim 1, wherein the radius of said rod member is substantially smaller than the radius of said developer roller.

6. The doctor blade as claimed in claim 1, wherein said bracket member comprised a stamped sheet of steel.

7. The doctor blade as claimed in claim 6, further comprising mounting holes for facilitating attachment of said doctor blade to a developer assembly.

8. The doctor blade as claimed in claim 1, wherein said bracket member and said rod member are made of like material.

9. A developer assembly for regulating a thickness of a toner layer in an electrophotographic image forming apparatus comprising:
a rotating photosensitive drum having an electrostatic latent image formed thereon;
a charging device, disposed adjacent said photosensitive drum, for charging a surface of said photosensitive drum;
a rotating developing roller for forming a toner image on an electrostatic latent image of said photosensitive drum by transferring toner from the developing roller to said drum;
a rotating supplying roller for supplying toner to said developing roller, said supplying roller being adjacent said developing roller; and
a doctor blade for regulating the thickness of a toner layer on said developing roller so as to be at a uniform thickness, wherein said doctor blade comprise sa bracket member having a mounting end, a doctoring end and a bent portion connecting said mounting and said doctoring end;
a rod member coupled to said bracket member near said bent portion; and
wherein said rod member is electrically conductive and arranged to contact said developer roll during a toner metering process.

10. The developer assembly as claimed in claim 9, wherein said rod member is a steel rod.

11. The developer assembly as claimed in claim 10, wherein said steel rod is welded to said bracket member.

12. The developer assembly as claimed in claim 11, wherein said rod member is welded to said bracket member at said bent portion.

13. The developer assembly as claimed in claim 9, wherein the radius of said rod member is substantially smaller than the radius of said developer roller.

14. The developer assembly as claimed in claim 9, wherein said bracket member comprised a stamped sheet of steel.

15. The developer assembly as claimed in claim 14, further comprising mounting holes for facilitating attachment of said doctor blade to a developer assembly.

16. The developer assembly as claimed in claim 9, wherein said bracket member and said rod member are made of like material.

17. The developer assembly as claimed in claim 9, further comprising a mounting bracket for supporting said doctor blade in said developer assembly.

18. A doctor blade for metering electrophotographic toner on a surface of a developer roller, said blade comprising:
a stamped bracket having a mounting end, a doctoring end and a bent portion connecting said mounting and said doctoring end;
a steel rod coupled to said bracket member near said bent portion; and
wherein said rod member is electrically conductive and arranged to contact said developer roll during a toner metering process.

19. The doctor blade as claimed in claim 18, wherein said steel rod is welded to said stamped bracket.

20. The doctor blade as claimed in claim 18, wherein the radius of said steel rod is substantially smaller than the radius of said developer roller.
